(19) United States
(12) Patent Application Publication
(10) Pub. No.: US 2023/0058158 A1
(43) Pub. Date: Feb. 23, 2023

(54) AUTOMATED ITERATIVE PREDICTIVE MODELING COMPUTING PLATFORM

(71) Applicant: Allstate Insurance Company, Northbrook, IL (US)

(72) Inventors: Dylan Wienke, Frankfort, IL (US); Brian Paul Guntli, Arlington Heights, IL (US); Vishal Krishna Varma, Lisle, IL (US); Chien-Hsun Yu, Northbrook, IL (US); Yu Jen Liu, Chicago, IL (US)

(21) Appl. No.: 17/406,790

(22) Filed: Aug. 19, 2021

(51) Int. Cl. G06Q 40/08; G06N 5/04

(52) U.S. Cl. CPC G06Q 40/08; G06N 5/04

(57) ABSTRACT

Aspects of the disclosure relate to an automated iterative predictive modeling computing platform that iteratively requests additional data from external data sources to iteratively generate a more accurate insurance premium estimation. In some instances, the automated iterative predictive modeling computing platform may generate an insurance premium estimation using affordable insurance data and using estimated data in place of missing data. If the insurance premium estimation does not meet predefined confidence thresholds, the automated iterative predictive modeling computing platform may retrieve additional data that is more expensive but also has a likelihood to generate a more accurate insurance premium estimation. This process may be repeated using different data sets from different external data sources until a sufficiently accurate insurance premium estimate is generated by the automated iterative predictive modeling computing platform.

### BACKGROUND

Aspects of the disclosure relate to an automated iterative predictive modeling computing platform that may be utilized by an enterprise organization to provide insurance premium estimations to users. Many organizations provide insurance premium estimations to users. In some instances, however, these estimations may be highly inaccurate due to missing data. And in these instances, the users may be required to wait for days, weeks, and/or months before getting such an estimation. This is because current insurance premium software lacks the technical capabilities required to accurately estimate missing insurance data.

### SUMMARY

Aspects of the disclosure provide effective, efficient, scalable, and convenient technical solutions that address and overcome the technical problems associated with generation of insurance premium estimates.

In accordance with one or more embodiments, a computing platform comprising at least one processor, a communication interface communicatively coupled to the at least one processor, and memory may receive, for a plurality of missing data sets, a plurality of initial cost estimates. The computing platform may request, from an external data source and based on an analysis of a first initial cost estimate of the plurality of initial cost estimates, a first missing data set of the plurality of missing data sets. The computing platform may receive, from the external data source, the first missing data set. The computing platform may request, based on an analysis of a second initial cost estimate of the plurality of initial cost estimates, an estimated missing data set corresponding to a second missing data set of the plurality of missing data sets. The computing platform may request the estimated missing data set from a second computing platform. The computing platform and the second computing platform may be separate computing platforms or may be integrated within a single computing platform. The computing platform may receive the estimated missing data set. The estimated missing data set may be received from the second computing platform. The computing platform may input, into a predictive model, the first missing data set and the estimated missing data set. The computing platform may receive, from the predictive model, a first output comprising a first risk score and a first confidence level associated with the first risk score. The computing platform may request, from the external data source and based on an analysis of the first confidence level and a second analysis of the second initial cost estimate, the second missing data set. The computing platform may receive, from the external data source, the second missing data set. The computing platform may input, into the predictive model, the first missing data set and the second missing data set. The computing platform may receive, from the predictive model, a second output comprising a second risk score and a second confidence level associated with the second risk score.

In one or more instances, the computing platform may receive a request for an insurance premium estimation. The computing platform may identify, based on an analysis of the request, the plurality of missing data sets.

In one or more examples, the analysis of the first initial cost estimate may comprise comparing the first initial cost estimate to a first cost threshold. In one or more instances, the analysis of the second initial cost estimate may comprise comparing the second initial cost estimate to a second cost threshold.

In one or more instances, the analysis of the first confidence level may comprise comparing the first confidence level to a confidence threshold. In one or more instances, the analysis of the first confidence level may comprise determining that the first confidence level is below the confidence threshold.

In one or more arrangements, the computing platform may send, to a user device and based on a determination that the second confidence level is above a confidence threshold, the second output. In one or more instances, sending the second output to the user device may cause the user device to output the second output to a display of the user device.

In one or more instances, the estimated missing data set may be generated using a K-nearest neighbors machine learning algorithm.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A depicts an illustrative computing environment for an automated iterative predictive modeling computing platform in accordance with one or more example embodiments;

FIG. 1B depicts additional elements of an illustrative computing environment for implementing an automated iterative predictive modeling computing platform in accordance with one or more example embodiments;

FIG. 1C depicts additional elements of an illustrative computing environment for implementing an automated iterative predictive modeling computing platform in accordance with one or more example embodiments;

FIG. 1D depicts additional elements of an illustrative computing environment for implementing an automated iterative predictive modeling computing platform in accordance with one or more example embodiments;

FIGS. 2A-2I depict an illustrative event sequence for implementing an automated iterative predictive modeling computing platform in accordance with one or more example embodiments;

FIGS. 3A-3C depict an illustrative method for implementing an automated iterative predictive modeling computing platform in accordance with one or more example embodiments; and

FIGS. 4-5 depict an illustrative graphical user interface that implements an automated iterative predictive modeling computing platform in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to an automated iterative predictive modeling computing platform. To improve the accuracy and technical capabilities of insurance premium estimation software, an enterprise may implement an automated iterative predictive modeling computing platform that comprises the technical capabilities to automatically generate insurance premium estimations based on iteratively updated data sets.

As a brief summary, the description herein provides systems and methods for an automated iterative predictive modeling computing platform that iteratively requests additional data from external data sources to iteratively generate a more accurate insurance premium estimation. In some instances, an insurance premium estimation may be generated using standardized affordable insurance data and using estimated data in place of missing data. In other instances, the insurance premium estimation may be generated using all data in a non-standardized form (i.e. the original form). If the insurance premium estimation does not meet predefined confidence thresholds, the automated iterative predictive modeling computing platform may retrieve additional data that is more expensive but also has a likelihood to generate a more accurate insurance premium estimation. This process may be repeated using different data sets from different external data sources until a sufficiently accurate insurance premium estimate is generated by the predictive model.

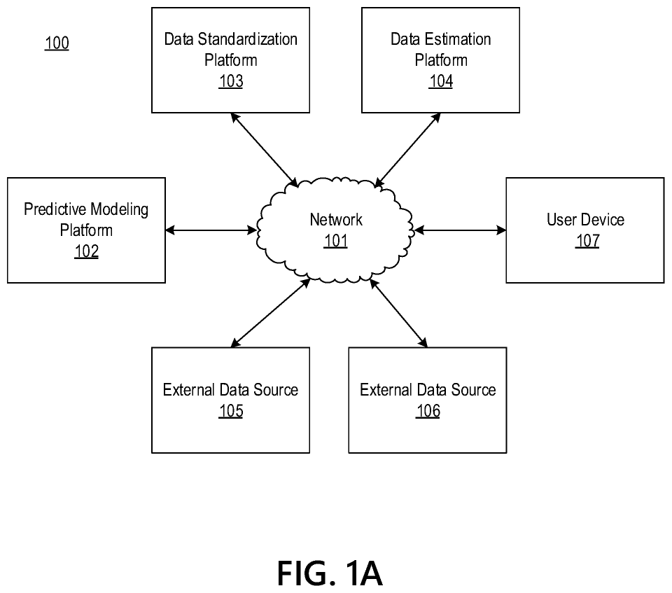

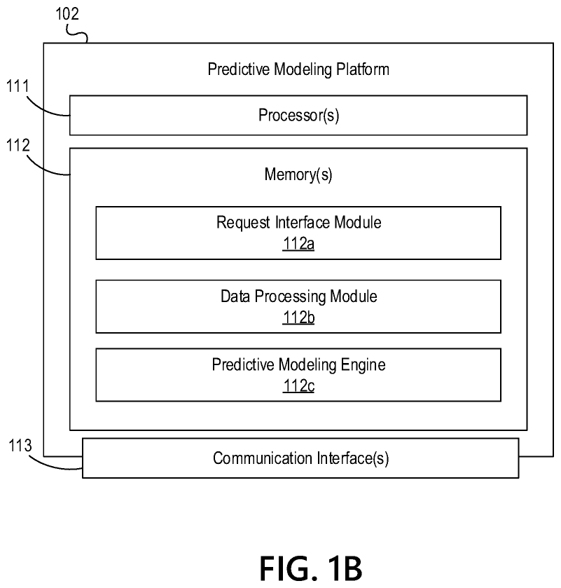

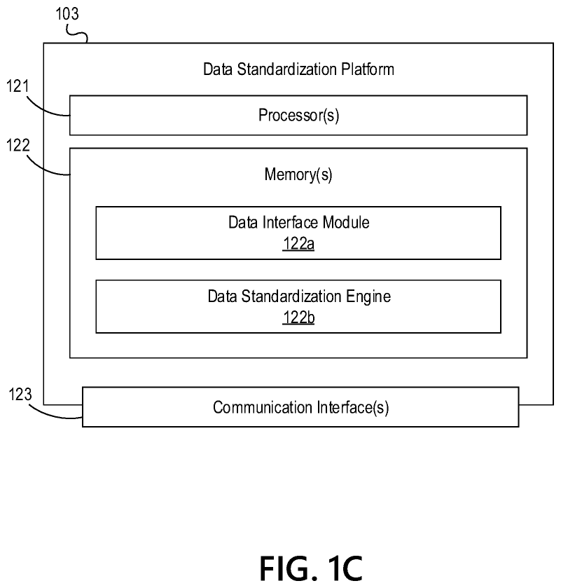

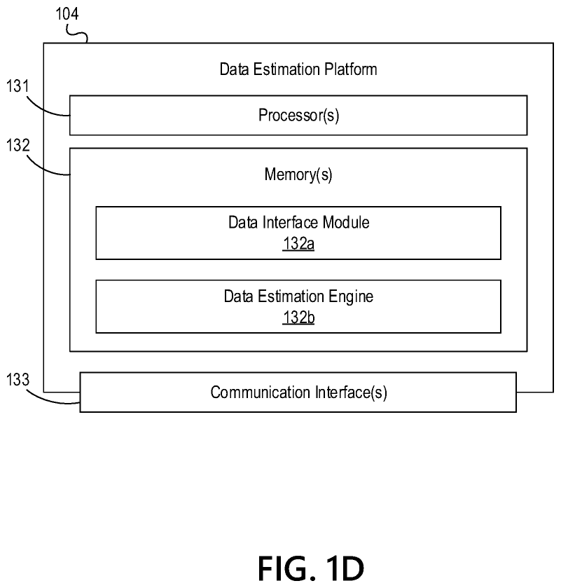

FIG. 1A depicts an illustrative computing environment for an automated iterative predictive modeling computing platform. Referring to FIG. 1A, computing environment 100 may include one or more computer systems. For example, computing environment 100 may include predictive modeling platform 102, data standardization platform 103, data estimation platform 104, external data source 105, external data source 106, and user device 107. Computing environment may also include one or more internal data sources for storing user data. Although FIG. 1A illustrates predictive modeling platform 102, data standardization platform 103, and data estimation platform 104 as being separate computing platforms, in another example, one or more of predictive modeling platform 102, data standardization platform 103, and data estimation platform 104 may be integrated into a single computing platform.

As illustrated in greater detail below, predictive modeling platform 102 may include one or more computing devices configured to perform one or more of the functions described herein. For example, predictive modeling platform 102 may include one or more computers (e.g., servers, server blades, desktop computers, laptop computers, mobile devices, tablets, or the like). In one or more instances, predictive modeling platform 102 may be configured to maintain various sub-processes within an insurance premium estimation generation process. In these instances, the predictive modeling platform 102 may leverage a predictive model to iteratively generate more precise insurance premium estimations. Additionally or alternatively, the predictive modeling platform 102 may be configured to use the various sub-processes to automatically generate insurance premium estimations without further manual intervention. Similarly, data standardization platform 103 may be a computer system that includes one or more computing devices (e.g., servers, server blades, or the like) and/or other computer components (e.g., processors, memories, communication interfaces) that may be used to standardize one or more data sets. Similarly, data estimation platform 104 may be a computer system that includes one or more computing devices (e.g., servers, server blades, or the like) and/or other computer components (e.g., processors, memories, communication interfaces) that may be used to generate one or more estimated missing data sets that each comprise estimated data for missing user data. External data source 105 and/or external data source 106 may be data sources maintained outside of the enterprise organization. External data source 105 and/or external data source 106 may be accessible by predictive modeling platform 102, data standardization platform 103, and/or data estimation platform 104 using network 101.

User device 107 may be a computer system that includes one or more computing devices (e.g., servers, server blades, laptop computers, desktop computers, mobile devices, tablets, smartphones, credit card readers, or the like) and/or other computer components (e.g., processors, memories, communication interfaces) that may be used to access enterprise services, such as those offered by predictive modeling platform 102, data standardization platform 103, and/or data estimation platform 104. In one or more instances, user device 107 may be configured to communicate with predictive modeling platform 102 to request and receive an estimated insurance premium. Although only one user device (user device 107) is shown in FIG. 1A, additional user devices may be configured to access the services offered by predictive modeling platform 102, data standardization platform 103, and/or data estimation platform 104.

Computing environment 100 also may include one or more networks, which may interconnect predictive modeling platform 102, data standardization platform 103, data estimation platform 104, external data source 105, external data source 106, and/or user device 107. For example, computing environment 100 may include a network 101 (which may interconnect, e.g., predictive modeling platform 102, data standardization platform 103, data estimation platform 104, external data source 105, external data source 106, and/or user device 107).

In one or more arrangements, predictive modeling platform 102, data standardization platform 103, data estimation platform 104, external data source 105, external data source 106, and/or user device 107, may be any type of computing device capable of sending and/or receiving requests and processing the requests accordingly. For example, predictive modeling platform 102, data standardization platform 103, data estimation platform 104, external data source 105, external data source 106, and/or user device 107, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of predictive modeling platform 102, data standardization platform 103, data estimation platform 104, external data source 105, external data source 106, and/or user device 107, may, in some instances, be special-purpose computing devices configured to perform specific functions.

Referring to FIG. 1B, predictive modeling platform 102 may include one or more processors 111, memory 112, and communication interface 113. A data bus may interconnect processor 111, memory 112, and communication interface 113. Communication interface 113 may be a network interface configured to support communication between predictive modeling platform 102 and one or more networks (e.g., network 101, or the like). Memory 112 may include one or more program modules having instructions that when executed by processor 111 cause predictive modeling platform 102 to perform one or more functions described herein and/or one or more databases that may store and/or otherwise maintain information which may be used by such program modules and/or processor 111. In some instances, the one or more program modules and/or databases may be stored by and/or maintained in different memory units of predictive modeling platform 102 and/or by different computing devices that may form and/or otherwise make up predictive modeling platform 102. For example, memory 112 may have, store, and/or include request interface module 112a, data processing module 112b, and predictive modeling engine 112c. Request interface module 112a may have instructions that direct and/or cause predictive modeling platform 102 to execute instructions for receiving a request for an estimated insurance premium, and for sending an insurance premium estimation. Data processing database 112b may have instructions that direct and/or cause predictive modeling platform 102 to execute instructions for analyzing data associated with the request to identify missing data for estimation, standardization, and/or retrieval. Predictive modeling engine 112c may have instructions that direct and/or cause the predictive modeling platform 102 to generate insurance premium estimations using a predictive model. Any data that is collected and/or analyzed by predictive modeling platform 102 may require the permission of one or more users associated with that data.

Referring to FIG. 1C, data standardization platform 103 may include one or more processors 121, memory 122, and communication interface 123. A data bus may interconnect processor 121, memory 122, and communication interface 123. Communication interface 123 may be a network interface configured to support communication between data standardization platform 103 and one or more networks (e.g., network 101, or the like). Memory 122 may include one or more program modules having instructions that when executed by processor 121 cause data standardization platform 103 to perform one or more functions described herein and/or one or more databases that may store and/or otherwise maintain information which may be used by such program modules and/or processor 121. In some instances, the one or more program modules and/or databases may be stored by and/or maintained in different memory units of data standardization platform 103 and/or by different computing devices that may form and/or otherwise make up data standardization platform 103. For example, memory 122 may have, store, and/or include data interface module 122a and data standardization engine 122b. Data interface module 122a may have instructions that direct and/or cause data standardization platform 103 to execute instructions for receiving data from one or more computer systems. Data standardization engine122b may have instructions that direct and/or cause data standardization platform 103 to execute instructions for standardizing data sets. Any data that is collected and/or analyzed by data standardization platform 103 may require the permission of one or more users associated with that data.

Referring to FIG. 1D, data estimation platform 104 may include one or more processors 131, memory 132, and communication interface 133. A data bus may interconnect processor 131, memory 132, and communication interface 133. Communication interface 133 may be a network interface configured to support communication between data estimation platform 104 and one or more networks (e.g., network 101, or the like). Memory 132 may include one or more program modules having instructions that when executed by processor 131 cause data estimation platform 104 to perform one or more functions described herein and/or one or more databases that may store and/or otherwise maintain information which may be used by such program modules and/or processor 131. In some instances, the one or more program modules and/or databases may be stored by and/or maintained in different memory units of data estimation platform 104 and/or by different computing devices that may form and/or otherwise make up data estimation platform 104. For example, memory 132 may have, store, and/or include data interface module 132a and data estimation engine 132b. Data interface module 132a may have instructions that direct and/or cause data estimation platform 104 to execute instructions for receiving data from computer systems. Data estimation engine 132b may have instructions that direct and/or cause data estimation platform 104 to execute instructions for estimating missing data from existing data sets. Any data that is collected and/or analyzed by data estimation platform 104 may require the permission of one or more users associated with that data.

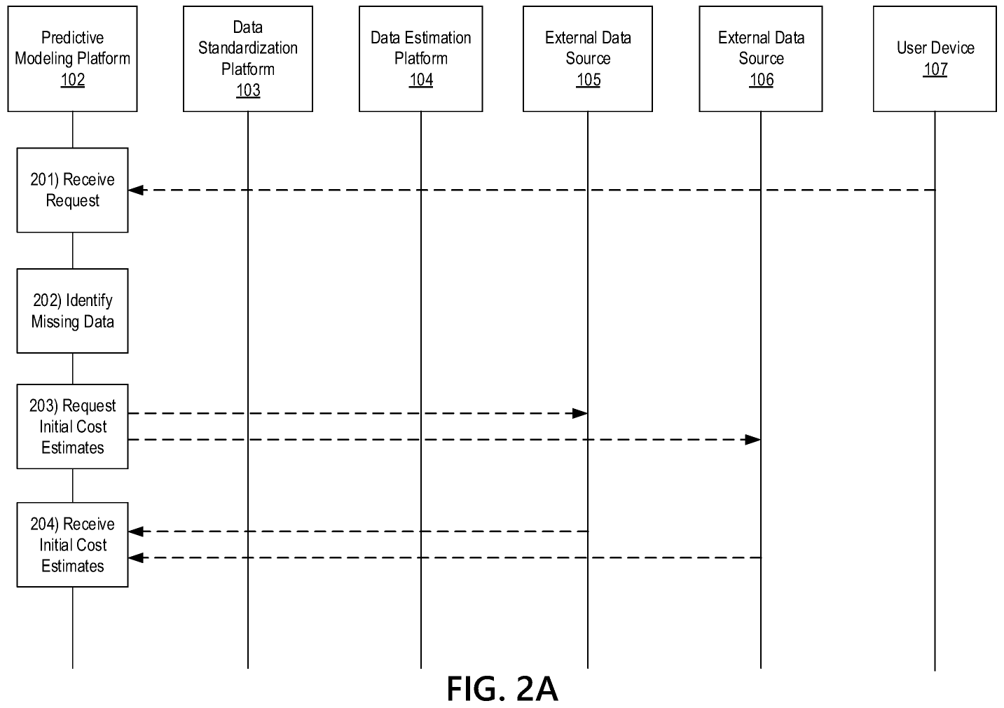

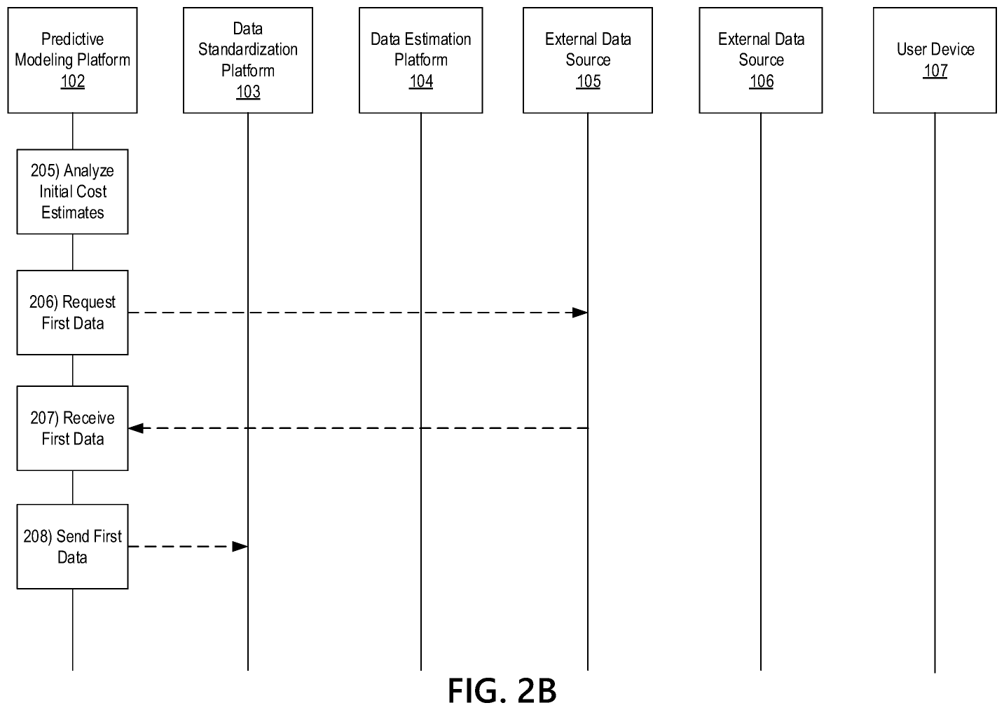

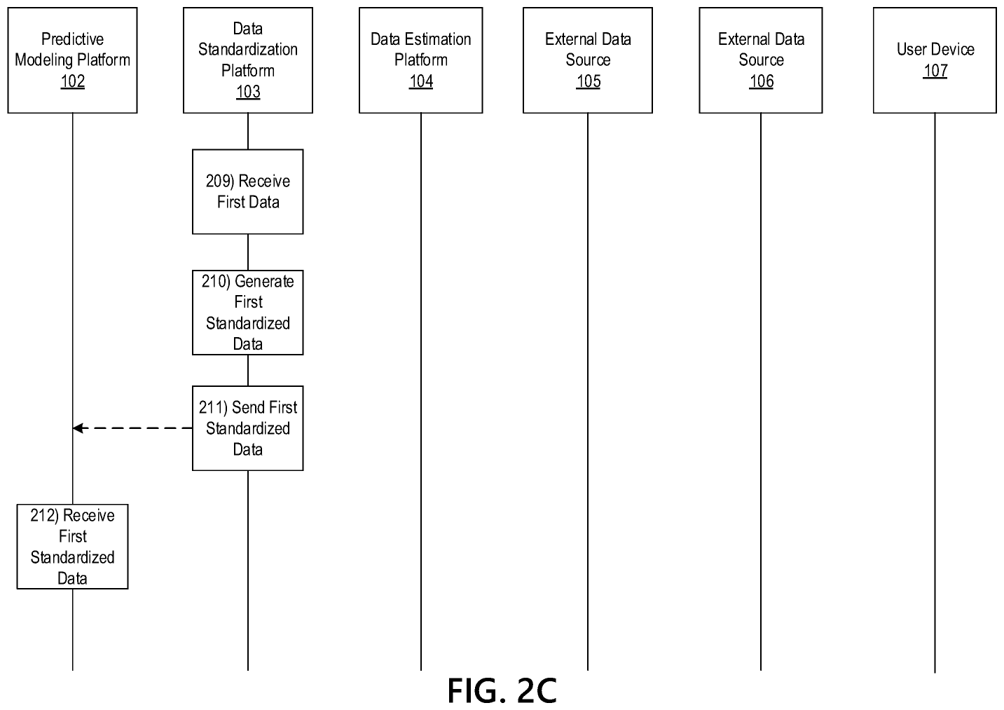

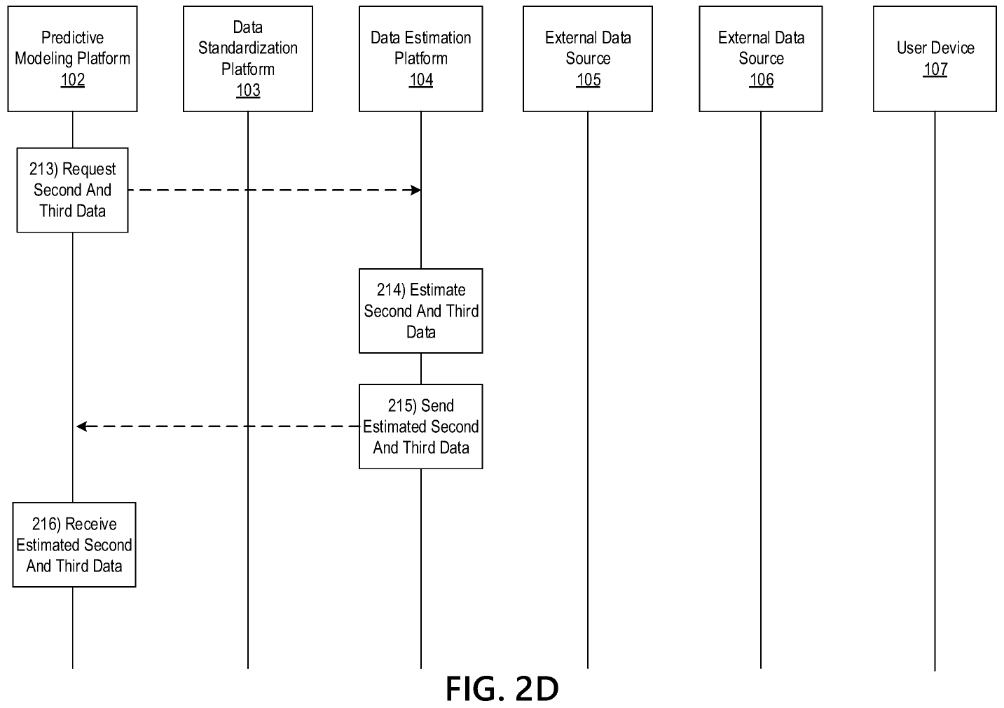

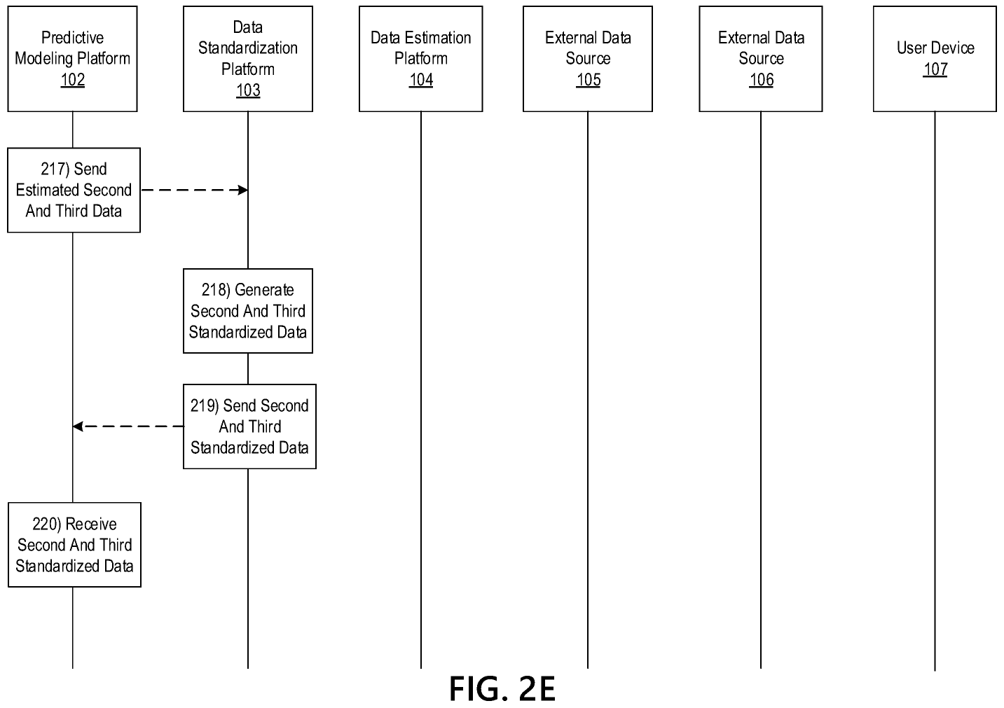

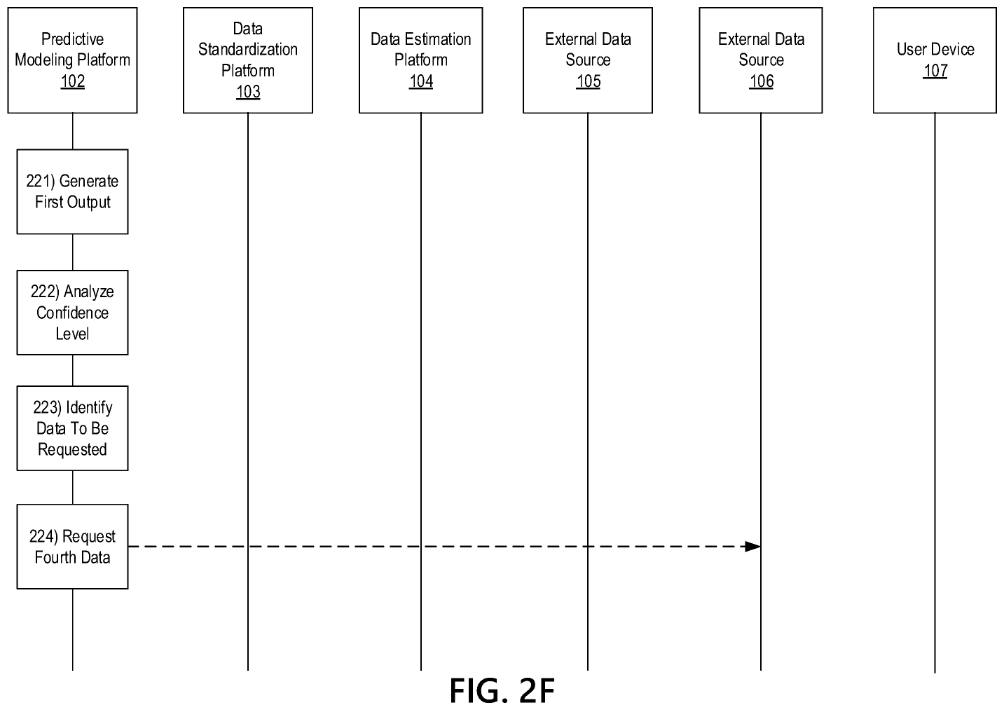

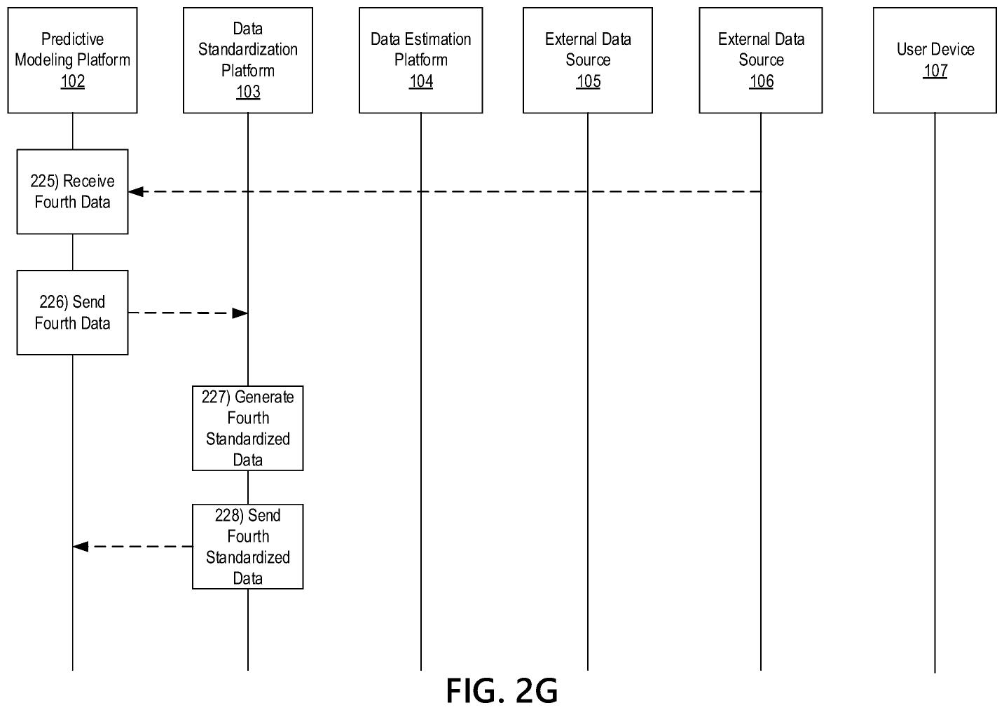

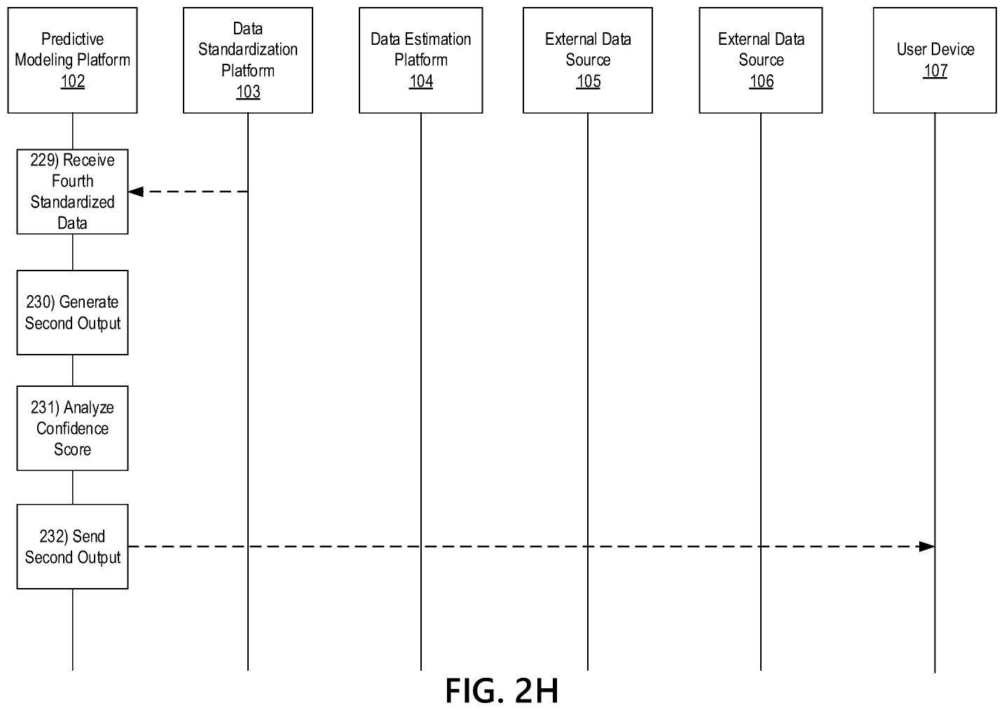

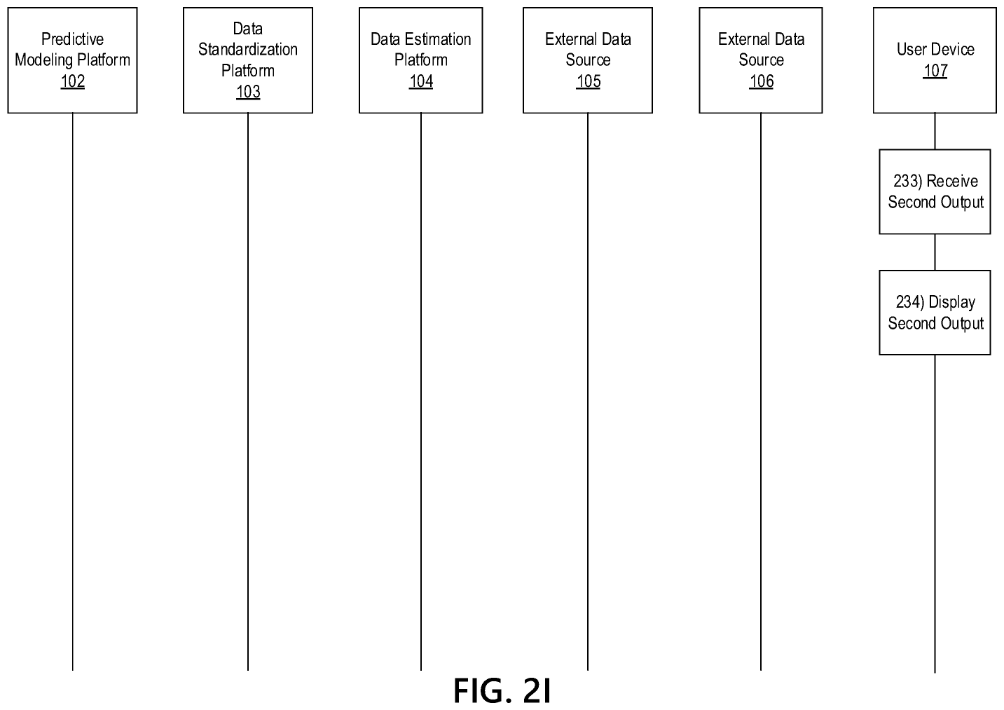

FIGS. 2A-2I depict an illustrative event sequence for implementing an automated iterative predictive modeling computing platform in accordance with one or more example embodiments. The steps shown in the event sequence of FIGS. 2A-2I are merely example steps and additional steps may be added, or steps omitted, without departing from the invention.

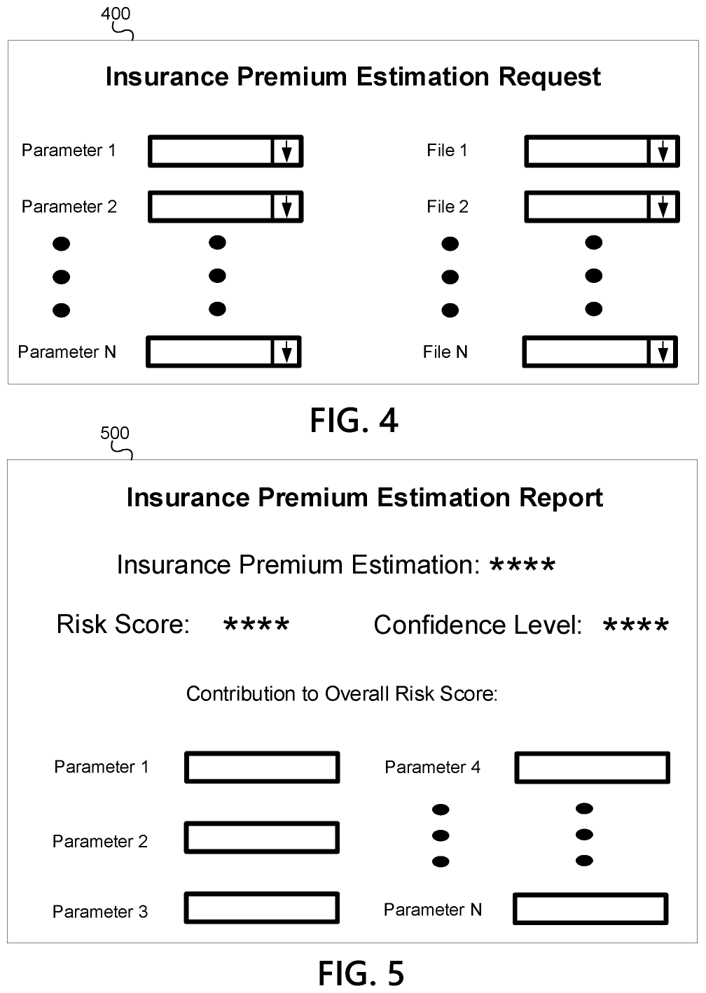

Referring to FIG. 2A, at step 201, predictive modeling platform 102 may receive a request from user device 107. In one example, the request may be for an insurance premium estimation. The request may first be received by user device 107 via a user interface. The request may be for an insurance premium estimation for life insurance, auto insurance, health insurance, and/or the like. An illustrative user interface is depicted in FIG. 4. User interface 400 may be output by user device 107 to receive the request that is subsequently sent from user device 107 to predictive modeling platform 102 at step 201. In addition to the request for the insurance premium estimation, the user may provide one or more parameters and one or more files associated with the insurance premium estimation. The one or more parameters may include any parameters relevant to the request for the insurance premium estimation, such as name, age, address, contact information, medical history, and/or the like. Similarly, the files may include any files relevant to the request for the insurance premium estimation, such as medical test results, medical history files, and/or the like. The parameters and/or files provided by the user via user interface 400 may be included in the request sent from user device 107 to predictive modeling platform 102 at step 201.

At step 202, predictive modeling platform 102 may analyze the existing data for the user associated with the request received by predictive modeling platform 102 at step 201 in order to identify missing data for the user that is needed by predictive modeling platform 102 to generate the insurance premium estimation. The existing data may include the data sent from user device 107 to predictive modeling platform 102 at step 201. The existing data may additionally or alternatively include data associated with the user and previously stored by predictive modeling platform 102, such as name, age, address, contact information, medical history, previous insurance premium information, current insurance policy information, and/or the like.

The missing data may include any biographical information associated with the user, the medical history of the user, medical test results of the user, past or current insurance policy of the user, accident or claim history, and/or the like. As a result of analyzing the existing data for the user associated with the request received by predictive modeling platform 102 at step 201, predictive modeling platform 102 may generate a list of missing data sets for the user and a corresponding external data source for each missing data set. In one example, predictive modeling platform 102 may determine that a first missing data set for the user may be retrieved from external data source 105, and that a second missing data set for the user and a third missing data set for the user may be retrieved from external data source 106.

At step 203, predictive modeling platform 102 may request, from each external data source, a cost estimate for retrieving the corresponding missing data set. Continuing with the example discussed above, predictive modeling platform 102 may request, from external data source 105, an estimated cost for retrieving the first missing data set for the user. Predictive modeling platform 102 may further request, from external data source 106, an estimated cost for retrieving the second missing data set for the user and an estimated cost for retrieving the third missing data set for the user.

At step 204, predictive modeling platform 102 may receive, from external data source 105 and external data source 106, and in response to the request sent from predictive modeling platform 102 to external data source 105 and external data source 106 at step 203, the requested cost estimates for retrieving the missing data sets for the user. Continuing with the example discussed above, predictive modeling platform 102 may receive, at step 204 and from external data source 105, a first cost estimate for retrieving the first missing data set for the user. And further continuing with the example discussed above, predictive modeling platform 102 may receive, at step 204 and from external data source 106, a second cost estimate for retrieving the second missing data set for the user and the third cost estimate for retrieving the third missing data set for the user.

Referring to FIG. 2B, at step 205, predictive modeling platform 102 may analyze each of the cost estimates received from external data source 105 and/or external data source 106 at step 204. Analysis of the cost estimates may include comparing the cost estimates to pre-stored cost thresholds or dynamically generated cost thresholds. Different cost thresholds may be associated with different missing data sets, based on the type of missing data. Analysis of the cost estimates may also include determining which missing data sets are to be retrieved (from external data source 105 and/or external data source 106) based on a result of comparing the cost estimates with the cost thresholds. Continuing with the example discussed above, predictive modeling platform 102 may determine, based on comparing a first cost threshold with the first cost estimate received from external data source 105 for retrieving the first missing data set for the user, that predictive modeling platform 102 is to retrieve the first missing dataset from external data source 105. And further continuing with the example discussed above, predictive modeling platform 102 may determine, based on comparing a second cost threshold with the second cost estimate received from external data source 106 for retrieving the second missing data set for the user, that predictive modeling platform 102 will not retrieve the second missing data set from external data source 106. And further continuing with the example discussed above, predictive modeling platform 102 may determine, based on comparing a third cost threshold with the third cost estimate received from external data source 106 for retrieving the third missing data set for the user, that predictive modeling platform 102 will not retrieve the third missing data set from external data source 106.

At step 206, predictive modeling platform 102 may request, from one or more data sources, the missing data sets identified at step 205. Continuing with the example discussed above, predictive modeling platform 102 may have determined, at step 205, that only the first missing data set is to be retrieved (e.g., the second missing data set and the third missing data set are not to be retrieved). Thus, at step 206, predictive modeling platform 102 may request the first missing data set from external data source 105. Although a missing data set is requested from only one data source in this example, missing data sets from a plurality of different sources may be requested without departing from the invention.

At step 207, predictive modeling platform 102 may receive, from external data source 105 and in response to the request sent from predictive modeling platform 102 to external data source 105 at step 206, the first missing data set. At step 208, predictive modeling platform 102 may send the first missing data set received by predictive modeling platform 102 from external data source 105 at step 207 to data standardization platform 103.

Referring to FIG. 2C, at step 209, data standardization platform 103 may receive the first missing data set from predictive modeling platform 102.

At step 210, data standardization platform 103 may generate a standardized data set corresponding the first missing data set received from predictive modeling platform 102. Data standardization platform 103 may be configured to standardize data sets to a predetermined format. That is, predictive modeling platform 102 may receive data sets, such as electronic health records, from various external data sources, such as external data source 105 and/or external data source 106. These data sets are essential in providing the insurance premium estimation as the data sets may include medical lab results and vital sign information. Generally, these data sets are not in unified or universal structured format. Thus, the formats of the different data sets, which may be retrieved from different external data sources, may vary significantly depending on the provider of the data set (for example, the medical provider) or the proprietary platform used to generate the data set. Thus, in order to properly leverage these different data sets in the predictive model, predictive modeling platform 102 may utilize data standardization platform 103 to standardize the different data sets. External data source 106 may include one or more modules to process and standardize the raw data in the data sets into a standardized data set that can be input into the predictive model of predictive modeling platform 102.

Standardization of the data sets by data standardization platform 103 may include one or more steps. For example, data standardization platform 103 may map lab test codes to key parameters needed for generating the insurance premium estimation. If multiple lap test codes map to the same parameter to be used by the predictive model, data standardization platform 103 may utilize a priority-based scheme to determine the particular lab test code to be mapped to the parameter needed by the predictive model of predictive modeling platform 102.

If lab test codes are missing from a data set, data standardization platform 103 may mine the text of the data set to locate the lab test codes. Mining the text of the data set may include, but is not limited to, cleaning up the text of the data set (removing symbols, standardizing white spaces, etc.), breaking up longer text strings into smaller key words, implementing text mining logic using tokenized text for generalizability, and/or the like. Data standardization platform 103 may further standardize the data sets by verifying all units of the data set and verifying the scale of results values of the data set (e.g., md/dL). Data standardization platform 103 may further standardize the data sets by converting all units therein for the same requirement to a common unit of measurement (for example, all g/dL values may be converted to mg/L values, etc.). Data standardization platform 103 may also standardize the data sets by validating the scale of the test results to ensure that the test results fall within a reasonable range. In one example, data that falls outside the reasonable range may be removed from the data set. As a result of standardizing a data set, data standardization platform 103 may generate a standardized data set that follows a predetermined structured format that is capable of being processed by the predictive model of predictive modeling platform 102.

At step 211, data standardization platform 103 may send the first standardized data set (e.g., the standardized data set generated by data standardization platform 103 and corresponding to the first missing data set retrieved by predictive modeling platform 102 from external data source 105) to predictive modeling platform 102. At step 212, predictive modeling platform 102 may receive the first standardized data set from data standardization platform 103.

Referring to FIG. 2D, at step 213, predictive modeling platform 102 may send a request for estimated data corresponding to the second missing data set and the third missing data set to data estimation platform 104. As discussed above with reference to steps 205 and 206, based on comparing the different cost estimates with the different cost thresholds, predictive modeling platform 102 may request particular missing data sets from external data sources at step 206. For the remaining missing data sets (e.g., missing data sets identified by predictive modeling platform 102 at step 202 but not requested by predictive modeling platform 102 at step 206), predictive modeling platform 102 may request corresponding estimated missing data sets from data estimation platform 104 at step 213. Continuing with the example discussed above, predictive modeling platform 102 may request the second missing data set and the third missing data set from data estimation platform 104.

At step 214, data estimation platform 104 may generate estimated missing data sets based on the request sent from predictive modeling platform 102 to data estimation platform 104 at step 213. Continuing with the example discussed above, data estimation platform 104 may generate an estimated second missing data set and an estimated third missing data set based on the request sent from predictive modeling platform 102 to data estimation platform 104 at step 213. The estimated second missing data set may comprise estimated data calculated by the data estimation platform 104 for the second missing data set. The estimated third missing data set may comprise estimated data calculated by the data estimation platform 104 for the third missing data set.

Data estimation platform 104 may include one or more models that data estimation platform 104 may utilize to estimate values in missing data sets. Data used to generate insurance premium estimations, such as electronic health records, may be a digital representation of the user's medical history. In certain instances, if the contents of the electronic health records are complete, or accurately estimated, the user may forgo the medical exams that are traditionally required in order to provide an insurance premium estimate. This beneficially provides the user with an insurance premium estimation much faster than the traditional process, because completion of the medical exams and receipt of the results of those medical exams can take multiple weeks. Existing insurance premium software does not have the technical ability to accurately estimate this missing data.

Accordingly, the models of data estimation platform 104 may include historical medical data from other individuals that may be leveraged to estimate the missing data for the user. In certain instances, data estimation platform 104 may only provide a subset of the missing data set. For example, the models may be configured to only generate estimates for parameters for which there is a predetermined minimal amount of historical data available. Additionally or alternatively, the models may be configured to only generate estimates for parameters for which estimated values will provide a minimal increase in accuracy for the insurance premium estimations. In one example, available data for a user may be used to estimate missing data for that user. Additionally, or alternatively, available data from other users may be used to estimate missing data for another user.

The models of data estimation platform 104 may be configured to use a K-Nearest Neighbors machine learning algorithm to identify other users with similar health profiles (e.g., neighbors) to estimate the values of missing data for a particular user. In particular, the models may identify a subset of one or more parameters that may collectively be used to calculate a missing parameter value. Each parameter in the subset of parameters may be assigned a weight based on the correlation of that parameter and the missing parameter value. That is, a first parameter in the subset of parameters that has a higher correlation to the missing parameter than a second parameter in the subset of parameters will be assigned a first weight that is higher than a second weight that is assigned to the second parameter.

For a missing parameter value for a user, data estimation platform 104 may first use the K-Nearest Neighbors algorithm to identify a group of neighbors that are the closest match to the user based on available health data for each of the individuals. Then, for each individual in the identified group of neighbors, data estimation platform 104 may retrieve the subset of weighted parameters that are to be used to calculate the missing parameter values. Data estimation platform 104 may then use those subsets of weighted parameters to calculate the missing parameter value. Data estimation platform 104 may repeat this process for each missing parameter value for the user.

Once data estimation platform 104 has performed the aforementioned process to generate an estimated parameter value for each missing parameter value in the missing data sets at step 214, data estimation platform 104 may send, to predictive modeling platform 102 and at step 215, the estimated missing data sets (which include the estimated parameter values). Continuing with the example discussed above, data estimation platform 104 may send the estimated second missing data set and the estimated third missing data set to predictive modeling platform 102 at step 215. At step 216, predictive modeling platform 102 may receive the estimated missing data sets from data estimation platform 104. Continuing with the example discussed above, predictive modeling platform 102 may receive the estimated second missing data set and the estimated third missing data set from data estimation platform 104 at step 216.

Referring to FIG. 2E, at step 217, predictive modeling platform 102 may send any data sets received from data estimation platform 104 at step 216 to data standardization platform 103 for standardization. Continuing with the example discussed above, predictive modeling platform 102 may send the estimated second missing data set and the estimated third missing data set to data standardization platform 103 for standardization. At step 218, data standardization platform 103 may standardize the data sets sent by predictive modeling platform 102 to data standardization platform 103 at step 217. Continuing with the example discussed above, data standardization platform 103 may generate a second standardized data set corresponding to the estimated second missing data set and a third standardized data set corresponding to the estimated third missing data set. The standardization process performed by data standardization platform 103 at step 218 may be similar to the standardization process performed by data standardization platform 103 at step 210.

At step 219, data standardization platform 103 may send the standardized data set(s) generated by data standardization platform 103 at step 218 to predictive modeling platform 102. Continuing with the example discussed above, at step 219, data standardization platform 103 may send the second standardized data set generated by data standardization platform 103 at step 218 and the third standardized data set generated by data standardization platform 103 at step 218 to predictive modeling platform 102.

At step 220, predictive modeling platform 102 may receive the standardized data sets generated by data standardization platform 103 at step 218 and sent by data standardization platform 103 at step 219. Continuing with the example discussed above, at step 220, predictive modeling platform 102 may receive the second standardized data set generated by data standardization platform 103 at step 218 and the third standardized data set generated by data standardization platform 103 at step 218.

Referring to FIG. 2F, at step 221, predictive modeling platform 102 may utilize its predictive model to generate a first insurance premium estimation. Predictive modeling platform 102 may generate the first insurance premium estimation by inputting one or more data sets generated by data standardization platform 103 into the predictive model and receiving, from the predictive model and based on the inputted standardized data sets, one or more outputs. In another example, predictive modeling platform 102 may generate the first insurance premium estimation by inputting the data sets received in steps 207 and 216 (that is, the first missing data set, the estimated second missing data set and the estimated third missing data set), into the predictive model and receiving, from the predictive model and based on the inputted data sets, one or more outputs (that is, the data sets may be used as-is, without standardization, by the predictive modeling platform 102). The estimated second missing data set may comprise estimated data calculated by the data estimation platform 104 for the second missing data set. The estimated third missing data set may comprise estimated data calculated by the data estimation platform 104 for the third missing data set.

Here, the predictive model may generate the first insurance premium estimation using the data received by predictive modeling platform 102 at step 201. Additionally or alternatively, the predictive model may generate the first insurance premium estimation using the data received by predictive modeling platform 102 from data standardization platform 103 at step 212. Additionally or alternatively, the predictive model may generate the first insurance premium estimation using the data received by predictive modeling platform 102 from data standardization platform 103 at step 230. Continuing with the example discussed above, predictive modeling platform 102 may, at step 221, utilize its predictive model to generate the first insurance premium estimation based on the first standardized data set received from data standardization platform 103 at step 212, the second standardized data set received from data standardization platform 103 at step 220, and the third standardized data set received from data standardization platform 103 at step 220. As discussed above, the predictive model may, in another example, generate the first insurance premium based on the first missing data set received at step 207 and the estimated second missing data set and the estimated third missing data set received at step 216.

In particular, the predictive model may analyze each of the standardized data sets (or the data sets in their original form) for the user to determine a risk score associated with the user. In addition, the predictive model may provide an indication of how each parameter value for the user (whether actual or estimated) affects that risk calculation. Such an indication may include a ranking of which parameter values are the highest contributors to the risk score. This enables the user to understand how different health related decisions will affect the risk score. For example, if the user's cholesterol level is the biggest contributor to a high insurance premium estimation for the user, the user can then work to lower their cholesterol level in order to lower their insurance premium. In addition to generating a risk score for the user and an indication of how different parameter values are affecting that risk score, the predictive model may generate a confidence level of the risk score. The confidence level may be indicative of the accuracy of the insurance premium estimation generated by the predictive model. For example, if the insurance premium estimation was generated based on a large number of estimated parameter values, the confidence level may be lower than if the insurance premium estimation was generated based on a small number of estimated parameter values. Finally, the predictive model of predictive modeling platform 102 may generate an insurance premium estimation based on the risk score.

At step 222, predictive modeling platform 102 may analyze the confidence level output by the predictive model of predictive modeling platform 102 at step 221. Predictive modeling platform 102 may analyze the confidence level by comparing the confidence level against a predetermined confidence threshold. If the confidence level is below the confidence threshold, processing may continue to step 223, where predictive modeling platform 102 may determine additional data for the user to be requested from an external data source. In particular, predictive modeling platform 102 may reanalyze the initial cost estimates received by predictive modeling platform 102 at step 204 from external data source 105 and/or external data source 106. Predictive modeling platform 102 may reanalyze the initial cost estimates by comparing the initial cost estimates to different cost thresholds (than those used in step 205) or the same cost thresholds.

At step 223, predictive modeling platform 102 may determine fourth data to be retrieved. As discussed above with reference to step 222, different cost thresholds or same cost thresholds may be used at step 222. For example, to generate the first insurance premium estimation, predictive modeling platform 102 may only retrieve data associated with a cost below a first cost threshold (e.g., the first missing data set retrieved by predictive modeling platform 102 from external data source 105 at steps 206/207) and may otherwise rely on estimated parameter values (e.g., the estimated second missing data set and the estimated third missing data set generated by data estimation platform 104). If the first insurance premium estimation generated by the predictive model of predictive modeling platform 102 is associated with a confidence level that is above a predefined confidence threshold, predictive modeling platform 102 may send the first insurance premium estimation to user device 107 (discussed below with reference to step 232). If, however, the first insurance premium estimation generated by the predictive model of predictive modeling platform 102 is associated with a confidence level that is below a predefined confidence threshold, predictive modeling platform 102 may retrieve more expensive data (e.g., data for which estimated values were initially used) and recalculate the insurance premium estimation. Continuing with the example discussed above, predictive modeling platform 102 may determine, at step 223 and based on different cost estimation thresholds, that the second missing data set (for which estimated parameter values were calculated and used for the generation of the first insurance premium estimation), referred to herein as the fourth missing data set, is to be retrieved. Accordingly, at step 224, predictive modeling platform 102 may request, from external data source 106, the fourth missing data set.

Referring to FIG. 2G, at step 225, based on the request sent from predictive modeling platform 102 to external data source 106 at step 224, predictive modeling platform 102 may receive the fourth data missing set from external data source 106. At step 226, predictive modeling platform 102 may send the fourth missing data set received from external data source 106 at step 225 to data standardization platform 103 for standardization. At step 227, external data source 106 may standardize the fourth missing data set sent by predictive modeling platform 102 at step 226. The standardization performed by data standardization platform 103 at step 227 may be similar to the standardization performed by data standardization platform 103 at step 210. At step 228, data standardization platform 103 may send the fourth standardized data set generated by data standardization platform 103 at step 227 to predictive modeling platform 102.

Referring to FIG. 2H, at step 229, predictive modeling platform 102 may receive the fourth standardized data set sent by data standardization platform 103 at step 228.

At step 230, predictive modeling platform 102 may utilize its predictive model to generate a second insurance premium estimation. The predictive model may generate the second insurance premium estimation using the same data used at step 210 to generate the first insurance premium estimation, except that the second standardized data set (which was based on estimated values for the user) may be replaced by the fourth standardized data set (which is based on actual values for the user). As discussed above with reference to step 221, predictive modeling platform 102 may use the data sets in their original, non-standardized form instead of using standardized data sets. Similar to the outputs generated by predictive modeling platform 102 at step 221, at step 230, in addition to the second insurance premium estimation, predictive modeling platform 102 may generate a second risk score, a second indication of how each parameter value for the user (whether actual or estimated) affects the second risk score, and a second confidence level of the second risk score.

At step 231, predictive modeling platform 102 may analyze the second confidence level generated by the predictive model of predictive modeling platform 102 at step 230. Predictive modeling platform 102 may analyze the second confidence level generated by predictive modeling platform 102 at step 230 using a similar process and confidence thresholds as discussed above with reference to step 222. If predictive modeling platform 102 determines that the second confidence level generated by predictive modeling platform 102 at step 230 is below the confidence threshold, processing may return to step 223.

Otherwise, processing may proceed to step 232 in response to predictive modeling platform 102 determining, at step 222, that the first confidence level is greater than a predetermined confidence threshold or determining, at step 231, that the second confidence level is greater than the predetermined confidence threshold. At step 232, predictive modeling platform 102 may send the outputs generated by predictive modeling platform 102 using its predictive model to user device 107. In particular, the output sent by predictive modeling platform 102 to user device 107 may include the risk score, the indication of how each parameter value contributes to the risk score, the confidence level of the risk score, and/or the insurance premium estimation.

The sending of the outputs from predictive modeling platform 102 to user device 107 may be configured to cause user device 107 to display the outputs on a display of user device 107. Specifically, referring to FIG. 2I, user device 107 may receive, at step 233, the output from predictive modeling platform 102. At step 234, user device 107 may display the output received by user device 107 from predictive modeling platform 102 at step 233. In one example, the user device 107 may generate a user interface comprising the risk score, the indication of how each parameter value contributes to the risk score, the confidence level of the risk score, and/or the insurance premium estimate. An illustrative user interface for displaying the output received from predictive modeling platform 102 at step 233 is shown in FIG. 5. User interface 500 includes the risk score, the indication of how each parameter value contributes to the risk score, and/or the confidence level of the risk score.

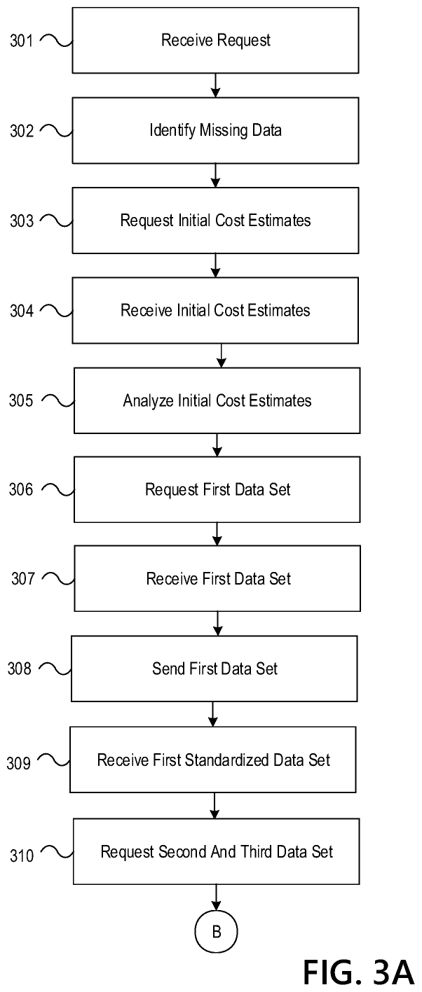

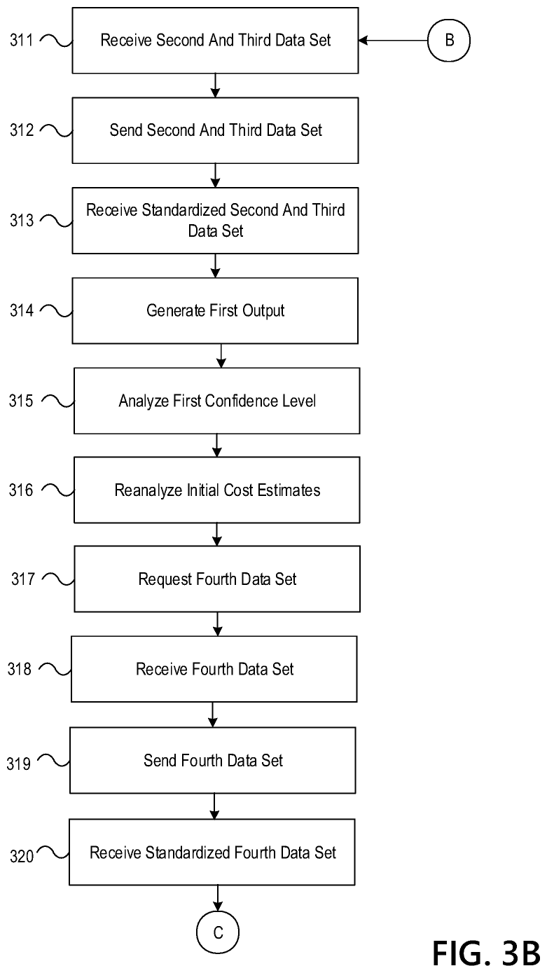

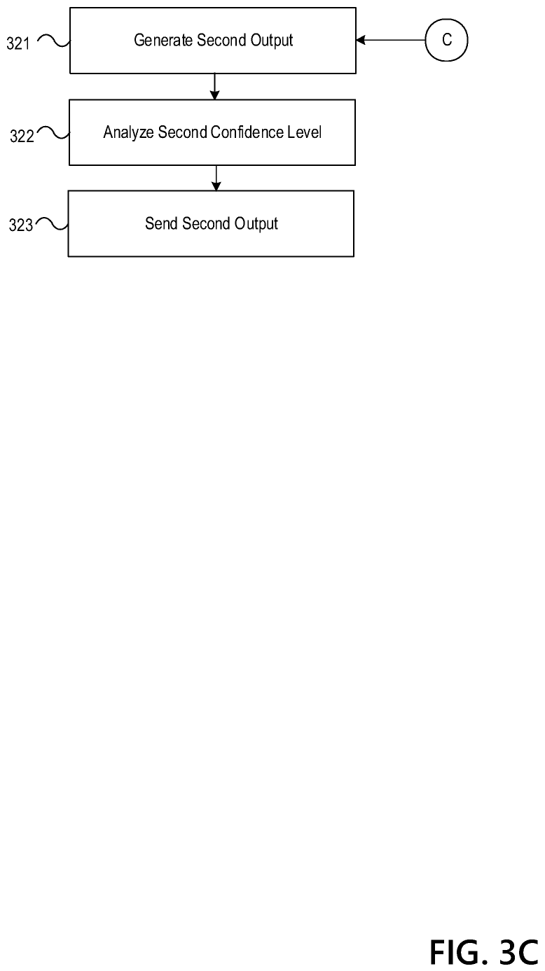

FIGS. 3A-3B depict an illustrative method for implementing an automated iterative predictive modeling computing platform in accordance with one or more example embodiments. Referring to FIG. 3A, at step 301, a computing platform having at least one processor, a communication interface, and a memory may receive a request for an insurance premium estimation. The request may comprise existing data for the user. At step 302, the computing platform may analyze the existing data for the user in order to identify missing data for the user that is needed by the computing platform to generate the insurance premium estimation. At step 303, the computing platform may request initial cost estimates for the missing data from one or more external data sources. At step 304, the computing platform may receive the requested initial cost estimates for the missing data from the one or more external data sources. At step 305, the computing platform may analyze the initial cost estimates for the missing data received from the one or more external data sources. At step 306, the computing platform may request a first missing data set corresponding to missing data from a first external data source. At step 307, the computing platform may receive the requested first missing data set from the first external data source. At step 308, the computing platform may send the first missing data set received from the first external data source to a data standardization platform. At step 309, the computing platform may receive a first standardized data set from the data standardization platform in response to the first missing data set sent to the data standardization platform. At step 310, the computing platform may request estimated data for a second missing data set and a third missing data set from a data estimation platform.

Referring to FIG. 3B, at step 311, the computing platform may receive the estimated second missing data set and the estimated third missing data set from the data estimation platform. The estimated second missing data set may comprise estimated data calculated by the data estimation platform for the second missing data set. The estimated third missing data set may comprise estimated data calculated by the data estimation platform for the third missing data set. At step 312, the computing platform may send the estimated second missing data set and the estimated third missing data set received from the data estimation platform to the data standardization platform. At step 313, the computing platform may receive a second standardized data set and a third standardized data set from the data standardization platform in response to the estimated second missing data set and the estimated third missing data set sent from the computing platform to the data standardization platform. At step 314, the computing platform may utilize a predictive model to generate a first output based on the first standardized data set, the second standardized data set, and the third standardized data set. Alternatively, the computing platform may utilize a predictive model to generate a first output based on the first missing data set, the estimated second missing data set and the estimated third missing data set (i.e., the data sets in their original form). The first output may include a first risk score, an indication of how each parameter value in the first missing data set, the estimated second missing data set, and/or the estimated third missing data set contributes to the first risk score, and/or a first confidence level of the first risk score. At step 315, the computing platform may analyze the first confidence level of the first risk score. At step 316, based on the analysis of the first confidence level of the first risk score, the computing platform may reanalyze the initial cost estimates received from the one or more external data sources. At step 317, the computing platform may request the fourth data set from the external data source. At step 318, the computing platform may receive the requested fourth missing data set from the external data source. The fourth missing data set may include one or more actual values for the user. At step 319, the computing platform may send the fourth missing data set to the second computing platform for standardization. At step 320, the computing platform may receive a fourth standardized data set from the second computing platform.

Referring to FIG. 3C, at step 321, the computing platform may utilize the predictive model to generate a second output based on the first standardized data set, the third standardized data set, and the fourth standardized data set (or the first missing data set, the estimated third missing data set, and the fourth missing data set, i.e., the original data sets in their non-standardized form). The second output may include a second risk score, an indication of how each parameter value in the first missing data set, the estimated third missing data set, and/or the fourth missing data set contributes to the second risk score, and/or a second confidence level of the second risk score. At step 322, the computing platform may analyze the second confidence level. At step 323, the computing platform may send the second output generated by the predictive model to a user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising:
at least one processor;
a communication interface communicatively coupled to the at least one processor; and
memory storing computer-readable instructions that, when executed by the at least one processor, cause the computing platform to:
receive, from a user device, a request for an insurance premium estimation;
receive, for a plurality of missing data sets, a plurality of initial cost estimates for retrieving the plurality of missing data sets;
when a first initial cost estimate of the plurality of initial cost estimates is below a first cost threshold, request a first missing data set of the plurality of missing data sets from an external data source;
receive, from the external data source, the first missing data set;
when a second initial cost estimate of the plurality of initial cost estimates exceeds a second cost threshold, request an estimated missing data set corresponding to a second missing data set of the plurality of missing data sets;
receive the estimated missing data set;
input, into a predictive model, the first missing data set and the estimated missing data set;
receive, from the predictive model, a first insurance premium estimation output comprising a first risk score and a first confidence level associated with the first risk score;
when the first confidence level is below a confidence threshold and the second initial cost estimate is below a third cost threshold, request the second missing data set from the external data source;
receive, from the external data source, the second missing data set;
input, into the predictive model, the first missing data set and the second missing data set;
receive, from the predictive model, a second insurance premium estimation output comprising a second risk score and a second confidence level associated with the second risk score; and
generate data to cause the user device to output the second insurance premium estimation output to a display of the user device based on a determination that the second confidence level is above a confidence threshold.

2. The computing platform of claim 1, wherein the memory stores additional computer-readable instructions that, when executed by the at least one processor, further cause the computing platform to:
identify, based on an analysis of the request, the plurality of missing data sets.

3-6. (canceled)

7. The computing platform of claim 1, wherein the memory stores additional computer-readable instructions that, when executed by the at least one processor, further cause the computing platform to:
send, to the user device and based on the determination that the second confidence level is above the confidence threshold, the second insurance premium estimation output.

8. (canceled)

9. The computing platform of claim 1, wherein the estimated missing data set is generated using a K-nearest neighbors machine learning algorithm.

10. A method comprising:
at a computing platform comprising at least one processor, a communication interface, and memory:
receiving, from a user device, a request for an insurance premium estimation;
receiving, for a plurality of missing data sets, a plurality of initial cost estimates for retrieving the plurality of missing data sets;
when a first initial cost estimate of the plurality of initial cost estimates is below a first cost threshold, requesting a first missing data set of the plurality of missing data sets from an external data source;
receiving the first missing data set;
when a second initial cost estimate of the plurality of initial cost estimates exceeds a second cost threshold, requesting an estimated missing data set corresponding to a second missing data set of the plurality of missing data sets;
receiving the estimated missing data set;
inputting, into a predictive model, the first missing data set and the estimated missing data set;
receiving, from the predictive model, a first insurance premium estimation output comprising a first risk score and a first confidence level associated with the first risk score;
when the first confidence level is below a confidence threshold and the second initial cost estimate is below a third cost threshold, requesting the second missing data set from the external data source;
receiving the second missing data set from the external data source;
receiving, from the predictive model, a second insurance premium estimation output comprising a second risk score and a second confidence level associated with the second risk score, wherein the second insurance premium estimation output is based on the first missing data set and the second missing data set; and
generating data to cause the user device to output the second insurance premium estimation output to a display of the user device based on a determination that the second confidence level is above a confidence threshold.

11. The method of claim 10, further comprising:
identifying, based on an analysis of the request, the plurality of missing data sets.

12-15. (canceled)

16. The method of claim 10, further comprising:
sending, to the user device and based on the determination that the second confidence level is above the confidence threshold, the second insurance premium estimation output.

17. (canceled)

18. One or more non-transitory computer-readable media storing instructions that, when executed by a computing platform comprising at least one processor, a communication interface, and memory, cause the computing platform to:
receive, from a user device, a request for an insurance premium estimation;
receive, for a plurality of missing data sets, a plurality of initial cost estimates for retrieving the plurality of missing data sets;
when a first initial cost estimate of the plurality of initial cost estimates is below a first cost threshold, request a first missing data set of a plurality of missing data sets from an external data source;
receive, from the external data source, the first missing data set;
when a second initial cost estimate of the plurality of initial cost estimates exceeds a second cost threshold, request an estimated missing data set corresponding to a second missing data set of the plurality of missing data sets;
receive the estimated missing data set;
input, into a predictive model, the first missing data set and the estimated missing data set;
receive, from the predictive model, a first insurance premium estimation output comprising a first risk score and a first confidence level associated with the first risk score;
when the first confidence level is below a confidence threshold and the second initial cost estimate is below a third cost threshold, request the second missing data set from the external data server;
receive, from the external data source, the second missing data set;
input, into the predictive model, the first missing data set and the second missing data set;
receive, from the predictive model, a second insurance premium estimation output comprising a second risk score and a second confidence level associated with the second risk score; and
generate data to cause the user device to output the second insurance premium estimation output to a display of the user device based on a determination that the second confidence level is above a confidence threshold.

19. The one or more non-transitory computer-readable media of claim 18, wherein the memory stores additional computer-readable instructions that, when executed by the at least one processor, further cause the computing platform to:
identify, based on an analysis of the request, the plurality of missing data sets.

20. The one or more non-transitory computer-readable media of claim 18, wherein the memory stores additional computer-readable instructions that, when executed by the at least one processor, further cause the computing platform to:
send, to the user device and based on the determination that the second confidence level is above the confidence threshold, the second insurance premium estimation output.

21. The computing platform of claim 1, wherein the third cost threshold is more expensive than the second cost threshold.

22. The method of claim 10, wherein the third cost threshold is more expensive than the second cost threshold.

23. The one or more non-transitory computer-readable media of claim 18, wherein the third cost threshold is more expensive than the second cost threshold.

24. The computing platform of claim 9, wherein the K-nearest neighbors machine learning algorithm identifies a group of neighbors that have a closest data match to the user, and wherein parameters of each of the group are used to calculate a missing parameter of the plurality of missing data sets.
